(19) United States
(12) Patent Application Publication
(10) Pub. No.: US 2010/0231291 A1
(43) Pub. Date: Sep. 16, 2010

(54) POWER SUPPLY

(75) Inventor: FAN WU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/499,156

(22) Filed: Jul. 8, 2009

(30) Foreign Application Priority Data
Mar. 13, 2009 (CN) 200910300835.8

(51) Int. Cl. G05F 1/02

(52) U.S. Cl. 327/540

(57) ABSTRACT

A power supply which supplies power to a circuit board includes a support unit, an electricity output unit and a voltage converting module. The circuit board, the electricity output unit and the voltage converting module are electrically connected to the support unit. The voltage converting module can convert an output voltage of the electricity output unit to a working voltage of the circuit board. The power supply has a low manufacturing cost and can support an electricity output unit with different voltage.

### BACKGROUND

1. Technical Field

The present disclosure generally relates to power supply, and particularly, to a power supply for supplying power to test and debug a circuit board.

2. Description of Related Art

When manufacturing mobile phones, circuit boards of the mobile phones need to be tested and debugged to ensure a stable and adequate performance. When testing the circuit boards, a power supply should be provided to supply power. At present, a circuit board generally receives power from a battery with a working voltage matching with the circuit board.

However, the tests may require a wide range of different power supplies which inevitably increases cost.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is a functional block diagram of a first embodiment of a power supply.

FIG. 2 is a functional block diagram of a second embodiment of a power supply.

### DETAILED DESCRIPTION

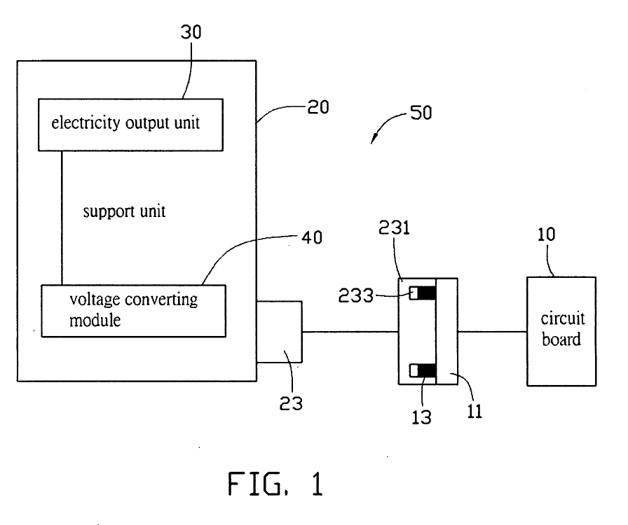

Referring to FIG. 1, a first embodiment of a power supply 50 used to supply power to a circuit board 10, includes a support unit 20, an electricity output unit 30, and a voltage converting module 40. The electricity output unit 30 and the voltage converting module 40 are electrically connected to the support unit 20, and electrically connected to each other via the support unit 20 The support unit 20 includes an output port 23. The circuit board 10 is electrically connected to the support unit 20 via the output port 23. The voltage converting module 40 is used to convert an output voltage of the electricity output unit 30 to the working voltage of the circuit board 10. In the illustrated embodiment, the circuit board 10 is applied in a mobile phone. In such a situation, the working voltage of the circuit board 10 is from about 3.6V to 4.2V The support unit 20 is a printed circuit board. The electricity output unit 30 is a battery. The voltage converting module 40 is a chip of MAX8606 of Maxim Integrated Products.

In use, the circuit board 10 is electrically connected to the output port 23 of the support unit 20. The electricity output unit 30 supplies power to the circuit board 10 after the output voltage of the electricity output unit 30 is converted to the working voltage of the circuit board 10 via the voltage converting module 40.

To conveniently connect the circuit board 10 to the support unit 20, a socket 231 including two receiving slots 233 is provided to connect to the output port 23, and a plug 11 including two pins 13 engaging in the receiving slots 233 correspondingly to connect to the circuit board 10.

The power supply 50 supplies power to the circuit board 10 via the electricity output unit 30, and the voltage converting module 40 electrically connects to the support unit 20, therefore The power supply 50 has a low manufacturing cost. In addition, the output voltage of the electricity output unit 30 can be converted to the working voltage of the circuit board 10 via the voltage converting module 40, thus, the electricity output unit 30 with different output voltages can be electrically connected to the support unit 20.

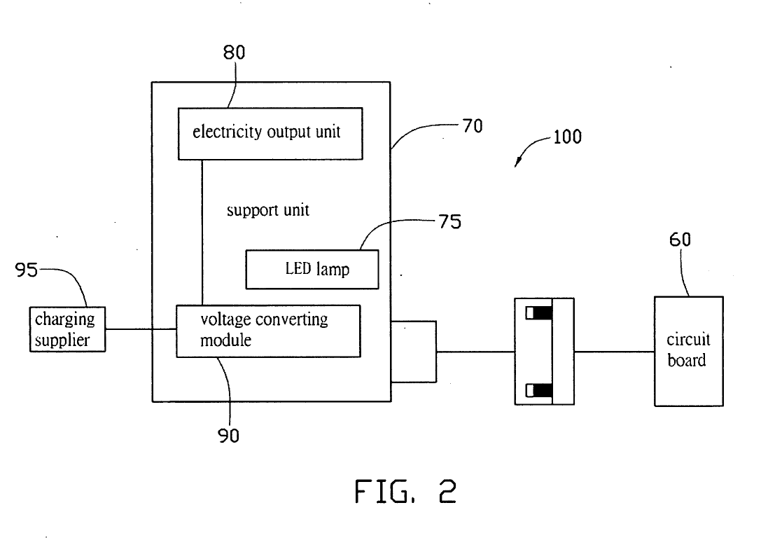

Referring to FIG. 2, a second embodiment of a power supply 100 is similar to The power supply 50 of the first embodiment, except that a voltage converting module 90 has an additional function of converting an output voltage of a charging supplier 95 to a working voltage of an electricity output unit 80 or a working voltage of a circuit board 60. The charging supplier 95 is connected to the voltage converting module 90. In the illustrated embodiment, the charging supplier 95 is connected to the voltage converting module 90 via a cable of a universal serial bus (USB). The voltage converting module 90 connects the electricity output unit 80 with the charging supplier 95 to charge the electricity output unit 80. The electricity output unit 80 is connected to the circuit board 60 to supply power to the circuit board 60. Power may be supplied by the electricity output unit 80 storing electricity or the charging supplier 95 directly. That is, the electricity output unit 80 may be omitted.

In use, the voltage converting module 90 judges whether the electric quantity of the electricity output unit 80 can supply power to a circuit board 60 or not. When no electricity is supplied to the circuit board 60 by the electricity output unit 80, the charging supplier 95 charges the electricity output unit 80 via converting the output voltage of the charging supplier 95 to the working voltage of the electricity output unit 80 to charge the electricity output unit 80. The electrical current flows from the electricity output unit 80, through the voltage converting module 90, and to the circuit board 60. If the output voltage of the electricity output unit 80 matches the working voltage of the circuit board 60, the electrical current just flows through the voltage converting module 90. If the output voltage of the electricity output unit 80 does not match the working voltage of the circuit board 60, the voltage converting module 90 converts the output voltage thereof to the working voltage of the circuit board 60 to supply power to the circuit board 60 via the voltage converting module 90. The charging supplier 95 can supply power continually, thus, the power supply 100 can supply power continually.

It can be understood that, a switch (not shown) and a light emitting diodes (LED) lamp 75 electrically connected to the support unit 70 are also provided. The switch is used to control the electrical current transmitted to the support unit 70 from the charging supplier 95. The LED lamp 75 is used to judge whether an electricity output unit 80 is fully charged or not.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

1. A power supply, used to supply power to test a circuit board, comprising:
a support unit;
an electricity output unit electrically connected to the support unit; and
a voltage converting module electrically connected to the support unit and used to convert an output voltage of the electricity output unit to a working voltage of the circuit board.

2. The power supply of claim 1, wherein the voltage converting module is a MAX8606 chip.

3. The power supply of claim 1, wherein the support unit is a printed circuit board.

4. The power supply of claim 1 further comprising a charging supplier electrically connected to the voltage converting module, used to charge the electricity output unit or supply power to the circuit board with output voltage converted to the working voltage of the circuit board.

5. The power supply of claim 4, wherein the charging supplier is electrically connected to the support unit via a USB cable.

6. The power supply of claim 5 further comprising a switch electrically connected to the support unit and used to control the electrical current transmitted to the support unit from the charging supplier.

7. The power supply of claim 6 further comprising a LED lamp electrically connected to the support unit and used to judge whether an electricity output unit is fully charged.

8. The power supply of claim 1, wherein a socket with two receiving slots is electrically connected to the support unit.

9. A power supply, comprising:
a support unit;
a voltage converting module electrically connected to the support unit; and
a charging supplier electrically connected to the voltage converting module, the output voltage of the charging supplier is converted to the working voltage of the circuit board.

10. The power supply of claim 9, wherein the charging supplier is electrically connected to the voltage converting module via a USB cable.

11. The power supply of claim 10 further comprising a switch electrically connected to the support unit and used to control the electrical current transmitted to the support unit from the charging supplier.

12. The power supply of claim 11 further comprising a LED lamp electrically connected to the support unit and used to judge whether an electricity output unit is fully charged.

13. The power supply of claim 9, wherein a socket with two receiving slots is electrically connected to the support unit.
